(19) United States
(12) Patent Application Publication
(10) Pub. No.: US 2021/0101238 A1
(43) Pub. Date: Apr. 8, 2021

(54) ROTATION DEVICE FOR A WORKPIECE

(71) Applicant: THE BOEING COMPANY, Chicago, IL (US)

(72) Inventors: James J. Troy, Issaquah, WA (US); William P. Motzer, Mount Pleasant, SC (US); Scott Wesley Lea, Renton, WA (US); Michael Craig Hutchinson, Kent, WA (US)

(73) Assignee: The Boeing Company

(21) Appl. No.: 16/594,989

(22) Filed: Oct. 7, 2019

(51) Int. Cl. B23Q 3/18

(52) U.S. Cl. CPC B23Q 3/18

(57) ABSTRACT

A rotation device to reorient a workpiece includes a retainer. The retainer accepts the workpiece in an open configuration and retains the workpiece in a closed configuration. The retainer forms two or more ring segments in the closed position. The rotation device includes a base to support the retainer. The base includes a plurality of retainer supports in working relation to the two or more ring segments to enable rotation of the retainer from a first orientation where the first structure contacts the retainer supports to a second orientation where the second structure contacts the retainer supports.

### FIELD OF THE DISCLOSURE

The present disclosure relates generally to a rotation device for a workpiece and more particularly to a rotation device for rotating a long, irregularly shaped workpiece (e.g., an aerodynamic structure of an aircraft).

### BACKGROUND

Some manufactured parts are long and have irregular shapes. During and after manufacturing of the manufactured parts, the manufactured parts may need to be rotated to provide access to one or more surfaces for further processing, for inspection (e.g., visual inspection or inspection by one or more imaging devices), or both. To rotate some long workpieces, a crane is used to lift and turn the workpiece while the workpiece remains attached to the crane. Rotating a long workpiece using a crane can be labor intensive, time consuming, and can place unwanted forces on the workpiece that have potential to damage the workpiece. It is desirable to have a rotation device that alleviates the need for a crane, is portable, and can be used to rotate a workpiece in a short amount of time as compared to rotating the workpiece using a crane.

### SUMMARY

The present disclosure describes rotation devices and methods for handling and rotating workpieces, such as an aerodynamic structure of an aircraft. The apparatus and methods allow for rotation of workpieces that are long, irregularly shaped, fragile, or combinations thereof. The rotation devices are portable, are not labor intensive to use, are easy to manufacture and operate, and are less expensive and quicker than using methods of rotation that involve the use of a crane.

In a particular example, a rotation device to reposition a workpiece includes a retainer. The retainer includes a first structure and a second structure coupled to the first structure. The first structure includes two or more first arcuate members and a plurality of first workpiece supports. The second structure includes two or more second arcuate members and a plurality of second workpiece supports. The second structure is moveable relative to the first structure to place the retainer in an open configuration to receive the workpiece and is movable relative to the second structure to place the retainer in a closed configuration to retain the workpiece in the retainer. The one or more first arcuate members are in working relation to the one or more second arcuate members to define two or more ring segments when the retainer is in the closed position. The rotation device also includes a base. Retainer supports coupled to the base contact the two or more ring segments and enable the ring segments to move relative to the retainer supports to rotate the retainer.

In another particular example, a rotation device to reorient a workpiece includes a retainer. The retainer accepts the workpiece in an open configuration and retains the workpiece in a closed configuration. The retainer forms two or more ring segments in the closed configuration. The rotation device includes a base to support the retainer. The base includes a plurality of retainer supports in working relation to the two or more ring segments to enable rotation of the retainer from a first orientation where the first structure contacts the retainer supports to a second orientation where the second structure contacts the retainer supports.

In another particular example, a method of rotating a workpiece includes positioning a retainer of a rotation device relative to the workpiece such that first workpiece supports of a first structure of the retainer are in contact with a first surface of the workpiece. The method includes moving a second structure of the retainer relative to the workpiece to a closed configuration such that second workpiece supports of the second structure are in contact with a second surface of the workpiece. The first structure and the second structure form two or more ring segments in the closed configuration. The method also includes rotating the two or more ring segments via retainer supports to rotate the retainer.

### BRIEF DESCRIPTION OF THE DRAWINGS

FIG. 1 is a perspective view of a rotation device with a retainer in a closed position.

FIG. 2 is a perspective view of the rotation device shown in FIG. 1 with the retainer in an open position.

FIG. 3 is a perspective view of the rotation device shown in FIGS. 1 and 2 with the retainer in a closed position and a workpiece positioned in the retainer.

FIG. 4 depicts a first side view representation of the rotation device shown in FIGS. 1-3 during use of the rotation device to rotate a workpiece.

FIGS. 5, 6, 7, 8, 9, 10, and 11 depict second side view representations of the rotation device shown in FIGS. 1-4 during use of the rotation device to rotate a workpiece.

FIG. 12 is a flow chart illustrating an example of a method of rotating a workpiece using a rotation device.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Systems, apparatuses, and methods disclosed herein are directed to rotation of a workpiece using a rotation device. The workpiece is rotated to position the workpiece in a particular orientation to facilitate further processing of the workpiece, visual or instrument inspection of the workpiece, to facilitate orientation of the workpiece for assembly to another workpiece, to facilitate access to one or more particular surfaces of the workpiece during manufacturing of the workpiece, or for other purposes. The workpiece may be long, bulky, heavy, fragile, or combinations thereof. The rotation device is a portable device that eliminates the need to employ the use of a crane to rotate the workpiece.

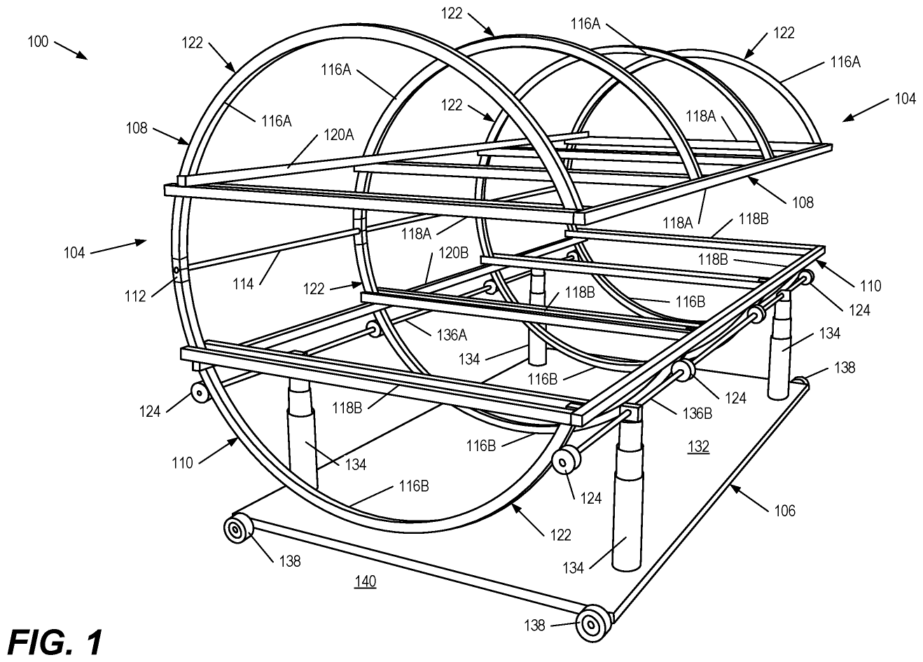

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each. In some cases, the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, arcuate members are illustrated and associated with reference number 116. When referring to a particular one of the arcuate members, such as the arcuate member 116A, the distinguishing letter “A” is used. However, when referring to any arbitrary one of the arcuate members, the reference number 116 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, the terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

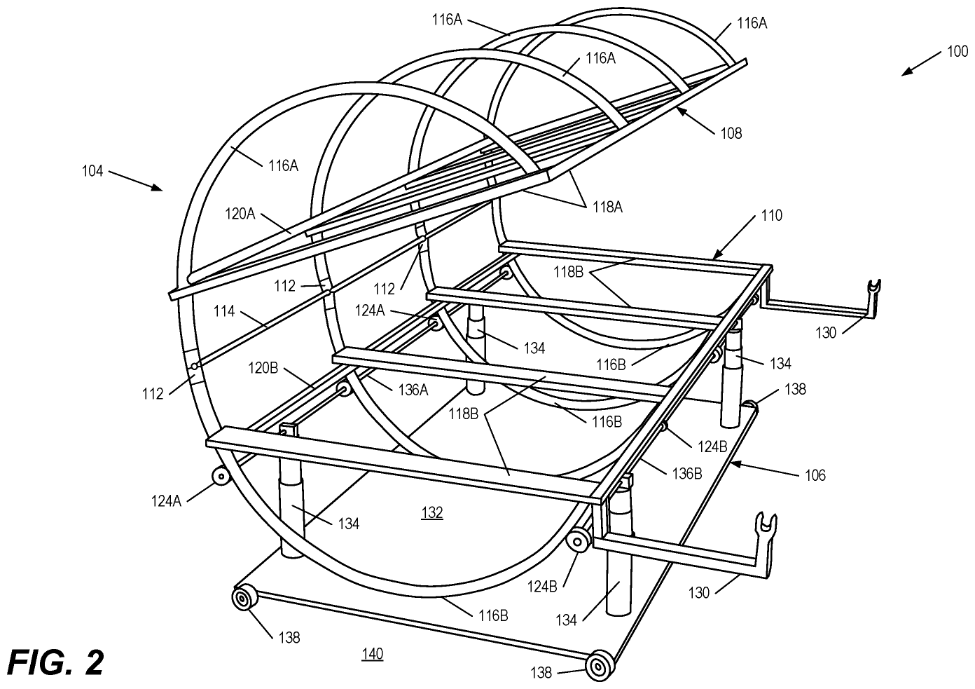

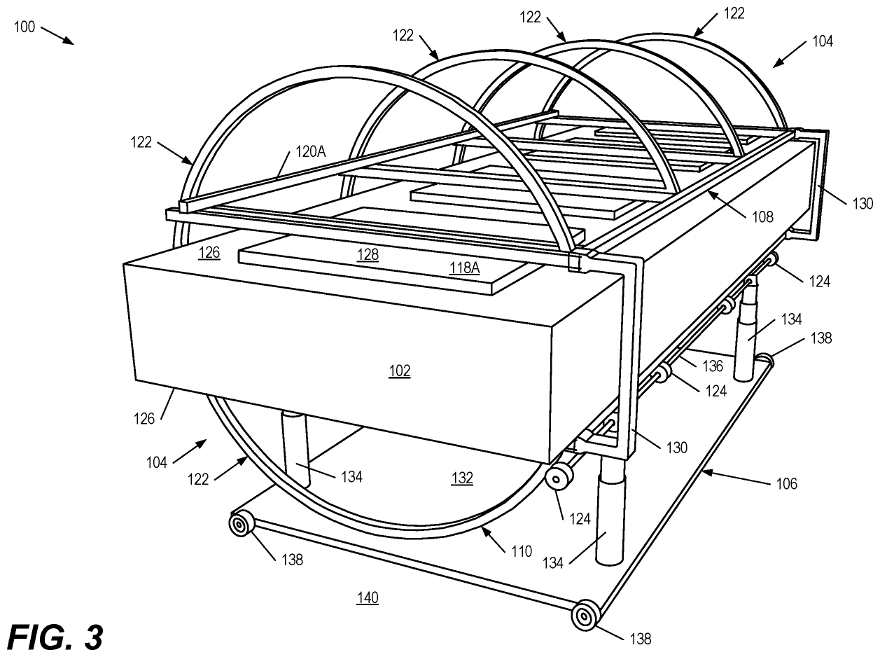

Referring now to the drawings, and more particularly to FIGS. 1-3, particular implementations of rotation devices 100 for rotating a workpiece 102 (shown in FIG. 3) are illustrated. In the illustrated embodiment, the workpiece 102 is a horizontal stabilizer for an aircraft. Thus, the rotation device 100 is configured to receive and rotate the horizontal stabilizer. However, it should be realized that the rotation device 100 may be utilized to receive and rotate a variety of workpieces, of which a horizontal stabilizer is one example. FIG. 1 depicts the rotation device 100 in a closed position. FIG. 2 depicts the rotation device 100 in an open position. FIG. 3 depicts the rotation device 100 in a closed position with the workpiece 102 secured in a retainer 104 of the rotation device 100. The rotation device 100 includes the retainer 104 and a base 106. The retainer 104 includes a framework of structural members to provide a sturdy, lightweight device.

The retainer 104 includes a first structure 108 coupled to a second structure 110. In a particular implementation, the first structure 108 is hinged to the second structure 110 by one or more hinges 112 to enable the retainer 104 to be moved from the closed position (as depicted in FIG. 1 and FIG. 3) to the open position (as depicted in FIG. 2). In some implementations, the first structure 108, the second structure 110, the one or more hinges 112, or combinations thereof, include one or more limiters to limit a range of rotation of the first structure 108 relative to the second structure 110. In other implementations, the rotation device 100 includes one or more linear actuators coupled to the first structure 108 and the second structure 110 to enable the first structure 108 to move rotationally relative to the second structure 110 to open or close the retainer 104.

One or more shafts 114 extend between hinges 112. Manual power or one or more linear actuators (e.g., hydraulic or pneumatic actuators) are used to open and close the retainer 104. When manual power is used to open the retainer 104 to an open configuration, one or more rotation stops are engaged to maintain the retainer 104 in the open configuration. The one or more rotation stops are disengaged to enable the retainer 104 to move from the open configuration to a closed configuration.

The first structure 108 includes one or more arcuate members 116A, a plurality of workpiece supports 118A, and one or more structure members 120A. The second structure 110 includes one or more arcuate members 116B, a plurality of workpiece supports 118B, and one or more structure members 120B. In FIG. 1, the first structure 108 and the second structure 110 each include four arcuate members 116 and four workpiece supports 118, but in other implementations, the first structure 108 and the second structure 110 each include fewer or more than four arcuate members 116 and four workpiece supports 118. The number of arcuate members 116 does not have to be the same as the number of workpiece supports 118. For example, in a particular implementation, the first structure 108 and the second structure 110 each include three arcuate member 116 and five workpiece supports 118.

When the first structure 108 is coupled to the second structure 110 to form the retainer 104 and the retainer 104 is in the closed position, arcuate members 116A of the first structure 108 and corresponding arcuate members 116B of the second structure 110 form ring segments 122. The ring segments 122 formed by corresponding arcuate members 116A, 116B form a cylindrically shaped framework with centers of the ring segments 122 formed by corresponding arcuate members 116A, 116B located along a central longitudinal axis of the cylindrical framework.

The ring segments 122 formed by corresponding arcuate members 116A, 116B are positioned on retainer supports 124 that are coupled to the base 106. The retainer supports 124 are rollers, pinion gears, chain links, or other components that contact the ring segments 122 formed by corresponding arcuate members 116A, 116B such that movement of the retainer supports 124 (e.g., rotation of the retainer supports 124) rotates the retainer 104. In an implementation, the retainer supports 124 are rollers that contact the ring segments 122 formed by corresponding arcuate members 116A, 116B such that rotation of the rollers causes the ring segments 122 to move relative to the rollers to rotate the retainer 104.

The workpiece supports 118 provide support for the workpiece 102 positioned in the retainer 104 between the first structure 108 and the second structure 110. The workpiece supports 118 are shaped or contoured to conform to one or more outer surfaces 126 of the workpiece 102 to be rotated by the rotation device 100. In the exemplary embodiment, when the workpiece 102 is embodied as a horizontal stabilizer for an aircraft, the outer surfaces 126 are contoured to conform to the outer surfaces of the horizontal stabilizer such that no damage occurs to the horizontal stabilizer while being installed into the rotation device or rotated by the rotation device 100. The workpiece supports 118 include padding 128, as depicted in FIG. 3. The padding 128 protects the outer surfaces 126 of the workpiece 102 that contact the workpiece supports 118. The shape of the workpiece supports 118 that conform to the workpiece 102, the padding 128, compression provided to the workpiece 102 by the workpiece supports 118 of the first structure 108 and the second structure 110, or combinations thereof, provide sufficient support to the workpiece 102 to inhibit or substantially inhibit movement of the workpiece 102 in the retainer 104 when the rotation device 100 is in use to rotate the workpiece 102. In some implementations, additional padding or shims can be placed between the workpiece 102 and the arcuate members 116 when the workpiece 102 is in the retainer 104 and before rotation to ensure that the workpiece 102 does not move and come into contact with the arcuate members 116 during rotation of the workpiece 102 by the rotation device 100.

When the workpiece 102 is positioned in the retainer 104 and the retainer 104 is in the closed position, one or more latches 130 are used to couple the first structure 108 to the second structure 110 to inhibit the retainer 104 from opening as the workpiece 102 is rotated. For workpieces 102 having widths that extend out of the retainer 104, the one or more latches 130 have a u-shape to accommodate a width portion of the workpiece 102 that extends out of the retainer 104. In the implementation depicted in FIG. 2, latches 130 are rotationally coupled to the second structure 110. In another implementation, the latches 130 include straps, cables, or cords that are secured to the first structure 108 and the second structure 110. The latches 130 are secured to the first structure 108, the second structure 110, or both, by friction fits, spring release mechanisms, sliding mechanisms, pins, bolts, or other types of fastening mechanisms. In other implementations, one or more latches 130, used to inhibit opening of the retainer 104 during rotation of the workpiece 102, are separate members coupled to the first structure 108 and the second structure 110 when the workpiece 102 is positioned in the retainer 104 and the retainer 104 is in the closed position. In some implementations, linear actuators can be used to open or close the retainer 104, thereby eliminating the need to secure the first structure 108 to the second structure 110 with latches 130 before rotation of the workpiece 102 positioned in the retainer 104.

The base 106 includes a sled 132, and supports 134. Axles 136 with the retainer supports 124 are coupled to the supports 134. The sled 132 includes wheels 138 to enable the rotation device 100 to be moved to a desired location. In an implementation, the sled 132 is coupled to rails that guide the rotation device 100 to or away from the workpiece 102. In some implementations the sled 132 includes a drive coupled to one or more of the wheels 138 that moves the sled 132. In other implementations, the sled 132 is manually positioned or positioned using a tow vehicle. When the sled 132 is in a desired location, a wheel lock mechanism is engaged to inhibit unintended movement of the sled 132.

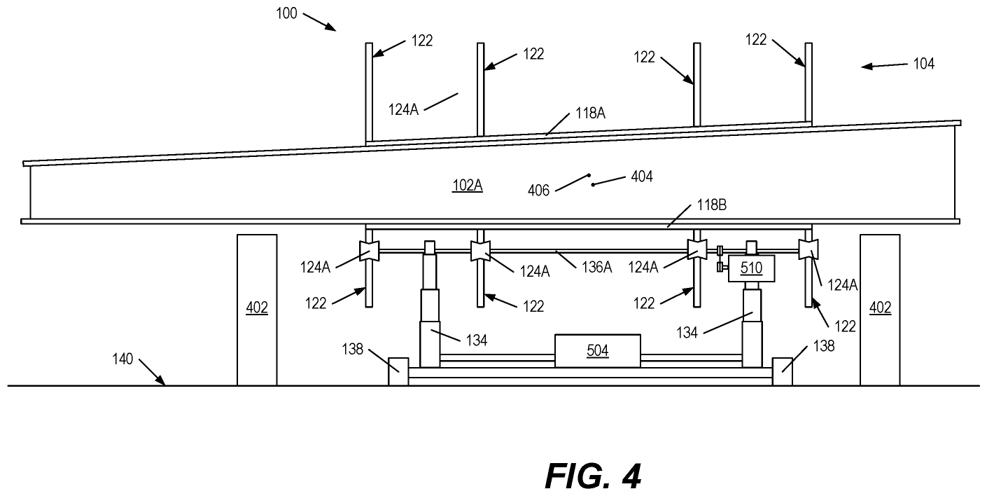

The supports 134 support the axles 136, and the retainer 104 is supported on retainer supports 124 coupled the axles 136. In a particular implementation, as depicted in FIG. 2, a first axle 136A is configured to be coupled to a drive mechanism (e.g., a hand crank or a drive motor, such as drive mechanism 510 depicted in FIGS. 4-11) that rotates the axle 136A. In the exemplary implementation, each of the drive retainer supports 124A are coupled to the first axle 136A so that the drive retainer supports 124A rotate as the first axle 136A rotates. In other implementations some of the retainer supports 124A coupled to the first axle 136A are not fixed to the first axle 136A and do not have to rotate as the first axle 136A rotates. Moreover, in the exemplary implementation, retainer supports 124B coupled to the second axle 136B are also configured to rotate when the second axle 136B rotates. When the workpiece 102 is positioned in the retainer 104, the retainer 104 is in the closed position, and the first structure 108 is secured to the second structure 110 by latches 130 to inhibit the retainer 104 from opening, the drive mechanism is engaged to rotate the axle 136A. Frictional engagement between the drive retainer supports 124A and corresponding ring segments 122 of the retainer 104 positioned on the drive retainer supports 124A causes the retainer 104 to rotate as the axle 136A rotates. In an alternate implementation, some of the retainer supports 124 are not fixed to the axles 136 so that the retainer supports 124 are configured to freewheel when the axles 136 rotate. In use, one or more users of the rotation device 100 grip portions of the retainer 104 and physically rotate the retainer 104 via the retainer supports 124, which eliminates the need for a drive mechanism. In other implementations, the retainer supports 124 include one or more pinion gears with gear teeth that engage gear teeth of the ring segments 122 formed by corresponding arcuate members 116A, 116B in order for the rotation device 100 to handle higher loads and reduce slippage. In some implementations, both axles 136A, 136B are coupled to drive mechanisms and drive retainer supports 124A are fixed to both axles 136A, 136B.

In some implementation, heights of the supports 134 are adjustable to adjust a height of the retainer 104 relative to a floor 140. Enabling adjustment of the heights of the supports 134 enables the rotation device 100 to lift the workpiece 102 from fixed workpiece stands that support the workpiece 102. The supports 134 are coupled to a lift system (e.g., lift system 504 depicted in FIGS. 4, 5, and 8). A controller of the lift system monitors and controls raising or lowering of the supports 134 so that each support 134 is raised or lowered a same distance as the other supports 134. The lift system can be a hydraulic system, a pneumatic system, or a mechanical lift system that raises or lowers the supports 134 based on instructions received from the controller. In other implementations, the supports 134 are fixed supports, and the workpiece 102 is initially supported above the floor 140 on workpiece stands that are adjustable to accommodate needed height changes of the workpiece 102 relative to the rotation device 100.

When the workpiece 102 is positioned in the retainer 104 of the rotation device 100, portions of the workpiece 102 can extend out of the rotation device 100 (e.g., from one or more sides of the retainer 104, from a front of the retainer 104, or from combinations thereof). A center of mass of the workpiece 102 is located in the retainer 104 near a center point of the retainer 104.

FIG. 4 depicts a first side view representation showing a workpiece 102A positioned in the rotation device 100 during use of the rotation device 100 to rotate the workpiece 102A, where portions of the workpiece 102A extend out of the retainer 104 to each side of the retainer 104. The workpiece 102A tapers from a first end to a second end. The rotation device 100 is positioned between workpiece stands 402. The workpiece 102A is supported in the retainer 104 above the workpiece stands 402. The center of mass 404 of the workpiece 102A is located near the center point 406 of the retainer 104.

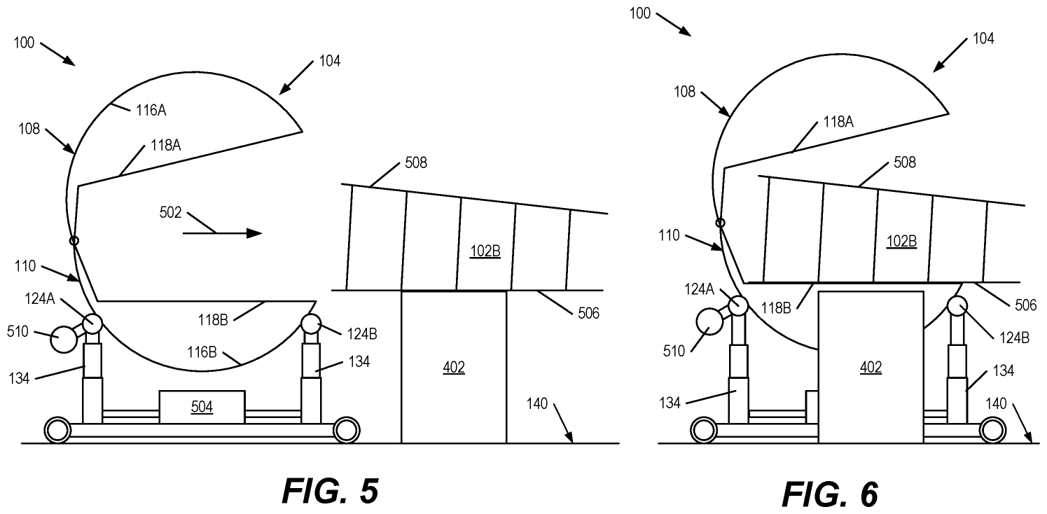

FIGS. 5-11 depict second side view representations showing a sequence of steps of use of the rotation device 100 to rotate a workpiece 102B. The workpiece 102B tapers from a first side to a second side. The rotation device 100 is used to rotate the workpiece 102B in the retainer 104 using the retainer supports 124 (e.g., rollers). The retainer 104 is initially in a first orientation before rotation where the second structure 110 of the retainer 104 is supported on the retainer supports 124. After rotation, the retainer 104 is in a second orientation where the first structure 108 of the retainer 104 is supported on the retainer supports 124. FIGS. 5-7 depict the retainer 104 in the first orientation, and FIGS. 9-11 depict the retainer 104 in the second orientation.

In FIG. 5, the retainer 104 of the rotation device 100 is in an open configuration and the rotation device 100 is being moved in direction 502 to position the second structure 110 under the workpiece 102B between workpiece stands 402. The workpiece 102B is positioned on the workpiece stands 402. When the rotation device 100 is positioned under the workpiece 102B, a lift system 504 is engaged to raise the supports 134 so that the workpiece supports 118B of the second structure 110 contact a first surface 506 of the workpiece 102B and lift the workpiece 102B off of the workpiece stands 402 so that the workpiece 102B is supported by the second structure 110. FIG. 6 depicts the workpiece 102B supported by the second structure 110.

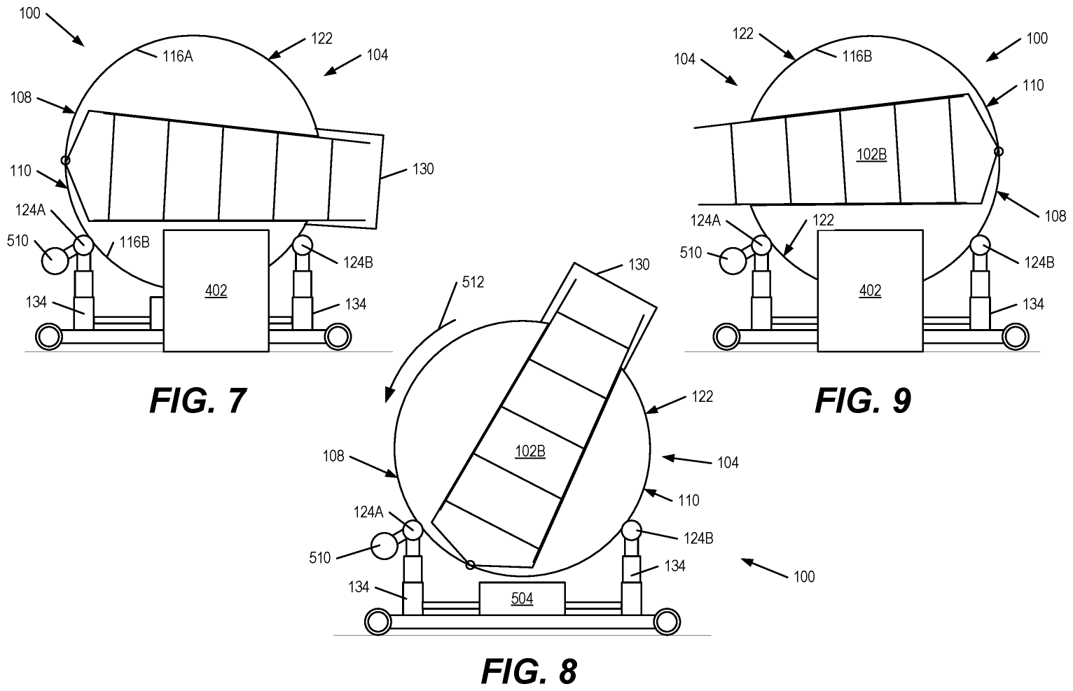

When the second structure 110 is supporting the workpiece 102B, the first structure 108 of the rotation device 100 is moved to contact a second surface 508 of the workpiece 102B with the workpiece supports 118A of the first structure 108 to place the rotation device 100 in a closed configuration. If needed, one or more latches 130 are coupled to the first structure 108 and the second structure 110 to inhibit the rotation device 100 from opening during rotation of the retainer 104. FIG. 7 depicts the retainer 104 in the closed configuration with the one or more latches 130 coupling the first structure 108 to the second structure 110 with the retainer 104 in a first orientation with the second structure 110 supporting the workpiece 102B. The rotation device 100 is moved away from the workpiece stands 402 and a drive mechanism 510 is engaged to rotate one or more drive retainer supports 124A so that the retainer 104 and the workpiece 102B positioned in the retainer 104 rotate. FIG. 8 depicts the rotation device 100 during rotation of the retainer 104 and the workpiece 102B in direction 512. In other implementations, instead of moving the rotation device 100 away from the workpiece stands 402, the supports 134 are raised higher with the lift system 504 such that the workpiece 102B in the retainer 104 will not contact the workpiece stands 402 during rotation of the retainer 104 and the workpiece 102B. FIG. 9 depicts the retainer 104 in a second orientation with the first structure 108 supporting the workpiece 102B.

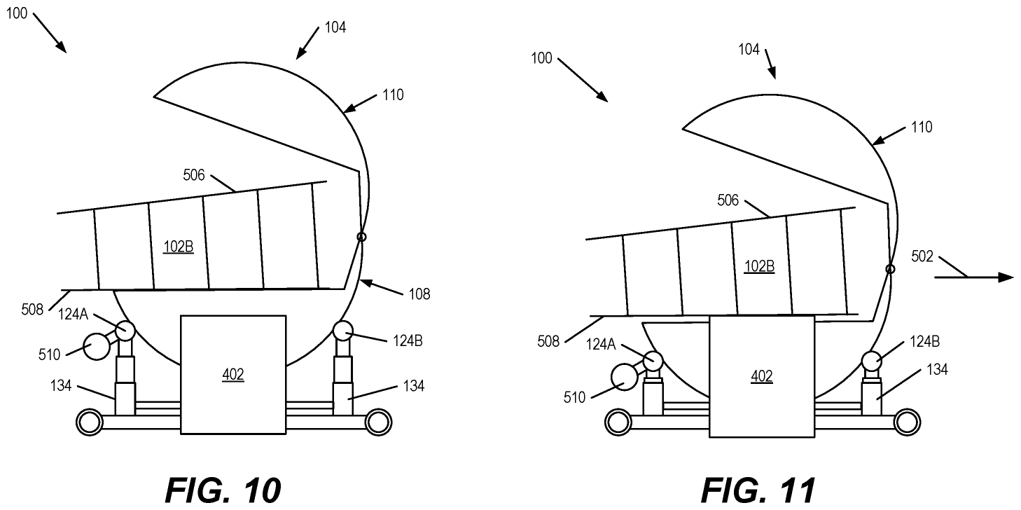

After rotation of the retainer 104 such that the workpiece 102B is oriented to reside on the workpiece stands 402, the rotation device 100 is moved between the workpiece stands 402 and the one or more latches 130 are removed from the first structure 108, the second structure 110, or both. FIG. 9 and FIG. 4 depict the rotation device 100 positioned between the workpiece stands 402. The first structure 108 is moved relative to the second structure 110 to place the retainer 104 in the open configuration. FIG. 10 depicts the retainer 104 in the open configuration. The lift system 504 is used to lower the retainer 104 so that the second surface 508 of the workpiece 102B is supported on the workpiece stands 402. FIG. 11 depicts the workpiece 102B supported on the workpiece stands 402. The rotation device 100 can then be moved in direction 502 away from the workpiece 102B.

In some implementations, the retainer 104 is used to rotate the workpiece 102 from an original orientation by a particular number of degrees to place the workpiece 102 in a particular orientation. When the workpiece 102 is in the particular orientation one or more tasks can be performed on the workpiece 102 while the workpiece 102 is in the retainer 104. After the one or more tasks are completed, the retainer 104 is rotated back to the original orientation, to a different orientation, the lift system 504 is used to set the workpiece 102 on the workpiece stands 402, or combinations thereof.

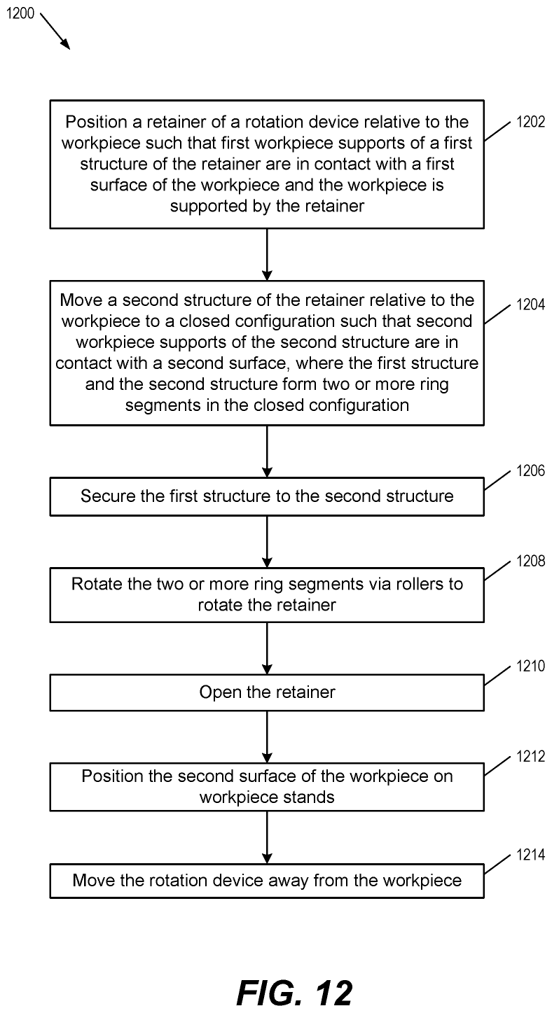

FIG. 12 is a flow chart illustrating an example of a method 1200 of rotating the workpiece 102 using the rotation device 100. The method 1200 is performed by the rotation devices 100 depicted in FIGS. 1-11. The method 1200 includes, at 1202, positioning the retainer 104 of the rotation device 100 relative to the workpiece 102 such that first workpiece supports 118A of the first structure 108 of the retainer 104 are in contact with a first surface of the workpiece 102 and the workpiece 102 is supported by the retainer 104.

Positioning the retainer 104 includes opening the retainer 104 to an open configuration to receive the workpiece 102. FIG. 5 and FIG. 6 depict the retainer 104 in the open configuration during the positioning the retainer 104. Positioning the retainer 104 includes rolling a portion of the base 106, which supports the retainer 104, under the workpiece 102. Rolling the portion of the base 106 under the workpiece 102 positions workpiece supports 118A of the first structure 108 under the workpiece 102 so that the workpiece 102 is positioned between the first structure 108 and the second structure 110 of the retainer 104. Positioning the retainer 104 also includes raising the retainer 104, or lowering workpiece stands 402 supporting the workpiece 102, so that the workpiece supports 118A support the workpiece 102. For example, in an implementation, the base 106 includes supports 134 that are extendable and retractable. Positioning the retainer 104 includes extending the supports 134 to lift the workpiece 102 off of the workpiece stands 402.

The method 1200 includes, at 1204, moving the second structure 110 of the retainer 104 relative to the workpiece 102 to a closed configuration. In the closed configuration, the workpiece supports 118B of the second structure 110 contact a second surface 508 of the workpiece 102 (shown in FIG. 6). In the closed configuration, which is depicted in FIG. 7, arcuate members 116A of the first structure 108 and corresponding arcuate members 116B of the second structure 110 form ring segments 122 in the closed configuration. Portions of the ring segments 122 are positioned on the retainer supports 124 coupled to the base 106.

The method 1200 includes, at 1206, securing the first structure 108 to the second structure 110. In an implementation, securing the first structure 108 to the second structure 110 includes coupling the first structure 108 to the second structure 110 using one or more latches 130, as depicted in FIG. 7.

The method 1200 includes, at 1208, rotating the ring segments 122 via retainer supports 124 to rotate the retainer 104. FIG. 8 depicts the retainer 104 and the workpiece during rotation of the ring segments 122. The retainer 104 is supported on retainer supports 124 which are attached to a pair of axles (e.g., axles 136 depicted in FIG. 1 and FIG. 2) coupled to the supports 134. A first axle 136A of the pair of axles is supported on a first pair of supports 134 and a second axle 136B of the pair of axles 136 is supported on a second pair of supports 134. Rotating the ring segments 122 includes engaging the drive mechanism 510 to rotate at least one of the axles 136A, 136B. In some implementations, the retainer 104, the base 106, or both, include a brake system, a rotation direction control (e.g., a ratchet system), a rack and pinion gear system, or combinations thereof, to inhibit uncontrolled rotation of the retainer 104, and to control rotation speed and rotation direction of the retainer 104 during use of the rotation device 100 to rotate the workpiece 102. In a particular implementation, the retainer 104 is rotated manually instead of by the drive mechanism 510.

The drive mechanism 510 is engaged to rotate the axle 136A that is fixed to one or more drive retainer supports 124A of the retainer supports 124. Rotation of the axle 136A rotates the drive retainer supports 124A and causes rotation of the retainer 104.

The method 1200 includes, at 1210, opening the retainer 104. Opening the retainer 104 includes uncoupling the one or more latches 130 from the first structure 108, the second structure 110, or both, and moving the first structure 108 relative to the second structure 110 to place the retainer 104 in the open configuration. FIG. 10 depicts the retainer 104 in the open configuration and located by workpiece stands 402.

The method 1200 includes, at 1212, positioning the second surface 508 of the workpiece 102 on the workpiece stands 402. The supports 134 of the base 106 are lowered, or the workpiece stands 402 are raised, to position the second surface 508 of the workpiece 102 on the workpiece stands 402. FIG. 11 depicts the second surface 508 of the workpiece 102 on the workpiece stands 402. The method 1200 also includes, at 1214, moving the rotation device 100 away from the workpiece 102.

The rotation device 100 has a simple design and is relatively inexpensive to manufacture. The rotation device 100 is configured to handle a workpiece, such as a wing structure of an aircraft, a wind turbine blade, or other long workpieces that are difficult to rotate due to their length, weight, fragility, or combinations thereof. The workpiece 102 is rotated to position particular surfaces of the workpiece for additional processing, for inspection, or both. The rotation device 100 is portable, inexpensive and light weight relative to cranes and alternate equipment used to rotate long workpieces, and the rotation device 100 is able to accommodate heavy, irregularly shaped, and fragile workpieces.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A rotation device to reposition a workpiece, the rotation device comprising:
a retainer including:
a first structure, wherein the first structure includes two or more arcuate members and a plurality of workpiece supports; and
a second structure coupled to the first structure, wherein the second structure includes two or more arcuate members and a plurality of workpiece supports, wherein the second structure is moveable relative to the first structure to place the retainer in an open configuration to receive the workpiece and is movable relative to the second structure to place the retainer in a closed configuration to retain the workpiece in the retainer, and wherein the one or more arcuate members of the first structure are in working relation to the one or more arcuate members of the second structure to define two or more ring segments when the retainer is in the closed configuration; and
a base, wherein retainer supports coupled to the base contact the two or more ring segments and enable the ring segments to move relative to the retainer supports to rotate the retainer.

2. The rotation device of claim 1, further comprising a latch to couple the first structure to the second structure to inhibit movement of the retainer from the closed configuration to the open configuration during rotation of the retainer.

3. The rotation device of claim 1, wherein the retainer supports comprise rollers.

4. The rotation device of claim 1, wherein the base includes a first axle, wherein a first plurality of the retainer supports support the two or more ring segments and are coupled to the first axle, and wherein one or more drive retainer supports of the first plurality of the retainer supports are fixed to the first axle to rotate as the first axle is rotated.

5. The rotation device of claim 4, further comprising a drive mechanism coupled to the first axle to rotate the one or more drive retainer supports, wherein rotation of the one or more drive retainer supports causes rotation of the retainer.

6. The rotation device of claim 4, wherein the base includes a second axle, wherein a second plurality of the retainer supports is coupled to the second axle, and wherein the ring segments are supported on the first plurality of the retainer supports and the second plurality of the retainer supports.

7. The rotation device of claim 1, wherein one or more of the workpiece supports of the first structure, one or more of the workpiece supports of the second structure, or combinations thereof, are contoured to correspond to outer surfaces of the workpiece.

8. The rotation device of claim 1, wherein one or more of the workpiece supports of the first structure, one or more of the workpiece supports of the second structure, or combinations thereof, include padding.

9. The rotation device of claim 1, wherein the base comprises a plurality of supports for the retainer.

10. The rotation device of claim 9, wherein the plurality of supports are extendable and retractable to enable adjustment of a height of the retainer relative to a floor.

11. A rotation device to reorient a workpiece, the rotation device comprising:
a retainer, wherein the retainer is configured to accept the workpiece in an open configuration, wherein the retainer is configured to retain the workpiece in a closed configuration, and wherein the retainer forms two or more ring segments in the closed configuration; and
a base to support the retainer, wherein the base includes a plurality of retainer supports in working relation to the two or more ring segments to enable rotation of the retainer from a first orientation where a first structure of the retainer contacts the retainer supports to a second orientation where a second structure of the retainer contacts the retainer supports.

12. The rotation device of claim 11, wherein the base includes a sled to enable the rotation device to be moved to accept the workpiece when the retainer is in the open configuration.

13. The rotation device of claim 11, wherein the base includes a first axle supported by a first pair of supports and a second axle supported by a second pair of supports, wherein a first set of the retainer supports are coupled to the first axle, and wherein a second set of the retainer supports are coupled to the second axle.

14. The rotation device of claim 13, wherein the first pair of supports and the second pair of supports are extendable and retractable to enable adjustment of a height of the retainer relative to a floor.

15. The rotation device of claim 13, wherein the retainer includes a plurality of workpiece supports, and wherein one or more of the workpiece supports include padding.

16. A method of rotating a workpiece, the method comprising:
positioning a retainer of a rotation device relative to the workpiece such that workpiece supports of a first structure of the retainer are in contact with a first surface of the workpiece;
moving a second structure of the retainer relative to the workpiece to a closed configuration such that workpiece supports of the second structure are in contact with a second surface of the workpiece, wherein the first structure and the second structure form two or more ring segments in the closed configuration; and
rotating the two or more ring segments via retainer supports to rotate the retainer.

17. The method of claim 16, wherein the retainer is supported on a base, and wherein the positioning the retainer relative to the workpiece comprises rolling a portion of the base under the workpiece.

18. The method of claim 16, wherein the retainer is supported on a pair of axles coupled to supports, and wherein rotating the two or more ring segments comprises engaging a drive mechanism to rotate at least one axle of the pair of axles.

19. The method of claim 16, wherein the retainer is supported on a base and wherein the workpiece is positioned on workpiece stands, and wherein the positioning the retainer includes lifting the workpiece from the workpiece stands by extending supports of the base.

20. The method of claim 19, further comprising lowering the workpiece to the one or more workpiece stands after rotating the two or more ring segments by retracting the supports of the base.
